(19) United States
(12) Patent Application Publication
(10) Pub. No.: US 2024/0062226 A1
(43) Pub. Date: Feb. 22, 2024

(54) METHOD FOR ALLOWING CONSUMER ACCESS TO AN ONLINE DATABASE PROVIDING SAFETY INFORMATION FOR BABY PRODUCTS

(71) Applicant: Andres Sanchez, Escondido, CA (US)

(72) Inventor: Andres Sanchez, Escondido, CA (US)

(21) Appl. No.: 17/892,005

(22) Filed: Aug. 19, 2022

(51) Int. Cl. G06Q 30/00

(52) U.S. Cl. CPC G06Q 30/0185

(57) ABSTRACT

A method for verifying the safety of a baby product. A baby product is inspected for safety. Safety compliance documents are generated as the result of the baby product inspection. The safety compliance documents include safety inspection results. The baby product is marked product with unique identification markings. The unique identification markings are also recorded on said safety compliance documents. The baby product and the safety compliance documents are forwarded to a safety verification and recording company where it is verified that the baby product passed inspection and that the identification markings on the baby product matches the identification markings on the safety compliance documents. A certificate of compliance is then issued. The certificate of compliance and the safety inspection results are uploaded to an online accessible database. The baby product is marked with a scan code that directs a scanner to the online accessible database. The scan code may then be scanned to access the online database to view the certificate of compliance and the safety inspection results.

The present invention relates to baby products, and in particular, to methods for permitting consumers to verify the safety of baby products.

### BACKGROUND OF THE INVENTION

When a consumer buys a baby product in a store or online, it can be very difficult for the purchaser to know if the product is truly safe. A baby's instinct is to put things in their mouth as that is their main way to learn and their most developed sense.

Baby products throughout the world are being manufactured and purchased at astronomical rates. It is often unclear, however, if the product is really safe for a baby, a toddler or a very young child. Consumers are forced to trust that the company providing the baby product actually did all the appropriate testing and the specific product being purchased was subject to the current testing.

Child product safety testing is a very costly process. For example, to truly have a product declared safe by government Consumer Product Safety Improvement Act (CPSIA) standards, a company needs to buy a mold for each batch that gives the product a unique number, and the company needs to have the ability to track the product down per the batch. Then the company will need to get each batch tested. This can cost upwards of $10000 per product. Also, the government has difficulty with efficient monitoring of the testing process. For these reasons, most businesses will skip the safety testing process.

There is no government agency that looks over or tests every product. The government simply lays out guidelines and companies are left to certify their own products. Furthermore, online stores such as Walmart.com, Instagram shop or Facebook stores, for example, do not ask for product safety tests. Instead, a product seller can set up their own website, order products from a manufacture and sell them, without testing.

Of recent interest, in 2021 the House of Representatives released a report that showed heavy metals were present in major baby food companies. So, the question remains, is the consumer left to just have blind trust that the baby companies will sell only safe baby toys? As of now, yes, a buyer is forced to “just trust” the baby product company.

What is needed is a device and method that provides transparency and validity in safety testing for baby products.

### SUMMARY OF THE INVENTION

The present invention provides a method for verifying the safety of a baby product. A baby product is inspected for safety. Safety compliance documents are generated as the result of the baby product inspection. The safety compliance documents include safety inspection results. The baby product is marked product with unique identification markings. The unique identification markings are also recorded on said safety compliance documents. The baby product and the safety compliance documents are forwarded to a safety verification and recording company where it is verified that the baby product passed inspection and that the identification markings on the baby product matches the identification markings on the safety compliance documents. A certificate of compliance is then issued. The certificate of compliance and the safety inspection results are uploaded to an online accessible database. The baby product is marked with a scan code that directs a scanner to the online accessible database. The scan code may then be scanned to access the online database to view the certificate of compliance and the safety inspection results.

### BRIEF DESCRIPTION OF THE DRAWINGS

FIG. 1 shows a flowchart depicting a preferred method of utilizing the present invention.

FIG. 2 shows a preferred connection between a consumer and the online database.

### DETAILED DESCRIPTION OF THE PREFERRED EMBODIMENTS

In a preferred embodiment a safety verification and reporting company is established and operates under the scope of public health, safety, environment and sustainability assessments. The safety verification and reporting company's standards are developed through a public process that ensures balanced input from industry professionals, public health/regulatory officials and users/consumer inputs. The safety verification and reporting company's auditing and certification services assure suppliers, retailers, regulators and consumers that an independent organization has reviewed a product or system to comply with current CPSIA standards for safety, quality, tracking and performance.

### COC Certification

Third-party Certification of Conformity (COC) is established by the safety verification and reporting company. The COC is important because it shows that an independent organization has reviewed the manufacturing process of a product and has independently determined that the final product complies with specific standards for safety, quality or performance. This review typically includes all but not always all, comprehensive formulation/material reviews, testing and facility inspections.

The safety verification and reporting company's standards are based on standards set by regulatory agencies at the local, state, federal and international levels. The COC certification demonstrates that a product or service complies with all standard requirements. The safety verification and reporting company conducts periodic facility audits and product testing to verify that the product continues to comply with all current regulatory agency standards.

After the safety verification and reporting company has inspected the baby product and has determined that the product is safe, the manufacturer of the product preferably places a scan code onto the packaging. Hence, all certified products will have a scan code mark on the packaging which will help consumers and other buyers make educated purchasing decisions around the safety of their baby product.

### Some Benefits of the Baby Product Safety Scan System

By utilization of the baby product safety scan system, baby product companies can now easily publicly display their compliance with national or international product safety standards and regulations. The baby product companies can now easily demonstrate independent third-party validation and verification of the baby product products. The baby product companies can now increase transparency of their safety compliance with retailers, consumers and regulators. These features will all help ensure safe products are sold.

### Safety Scan

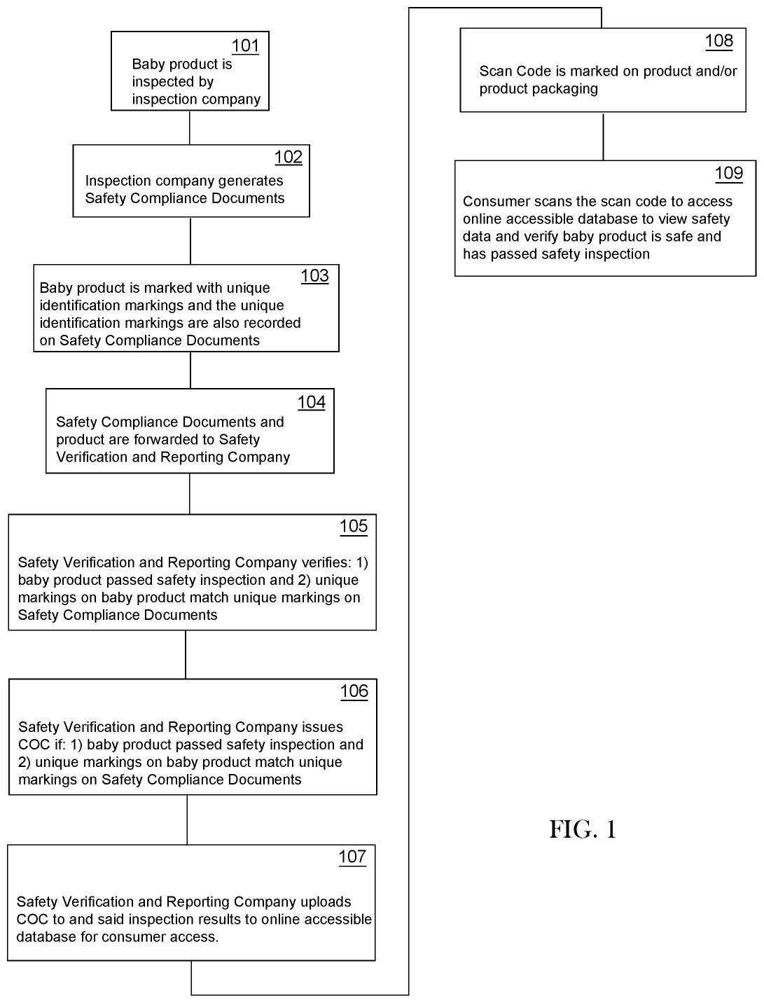

FIG. 1 shows a preferred flowchart outlining the proper steps for safety compliance.

The baby product company has the baby product inspected for safety compliance by an inspection company (step 101). Safety compliance documents are generated by the inspection company (step 102). The inspection company safety compliance documents preferably include: documents that show the results of laboratory tests of the products and a Child Product Safety Certificate (CPSC) verifying that the baby product has passed the inspection. The baby product is marked with unique markings (step 103) and these unique markings are recorded on the safety compliance documents.

After the documents are generated, the safety compliance documents are sent by the safety inspection company to the safety verification and reporting company (step 104).

The safety verification and reporting company will verify that the product passed inspection and that the unique markings shown on the compliance documents match the unique markings on the product (step 105). If the unique markings on the product match with the safety compliance documents and the safety compliance documents show that the product passed the safety inspection, then the safety verification and reporting company will issue the COC (step 106).

The COC will be uploaded onto an Internet accessible database which any consumer can access so as to read about safety status of the baby product (step 107). A product that has passed the inspection will then be given a scan code to display on their product or product packaging (step 108). This will give the consumer the ability to scan the code and be taken to the safety portal where all safety data will be shown as well as the COC (step 109). This way a consumer can feel safer that their product has been tested and evaluated by a third-party organization.

### Example

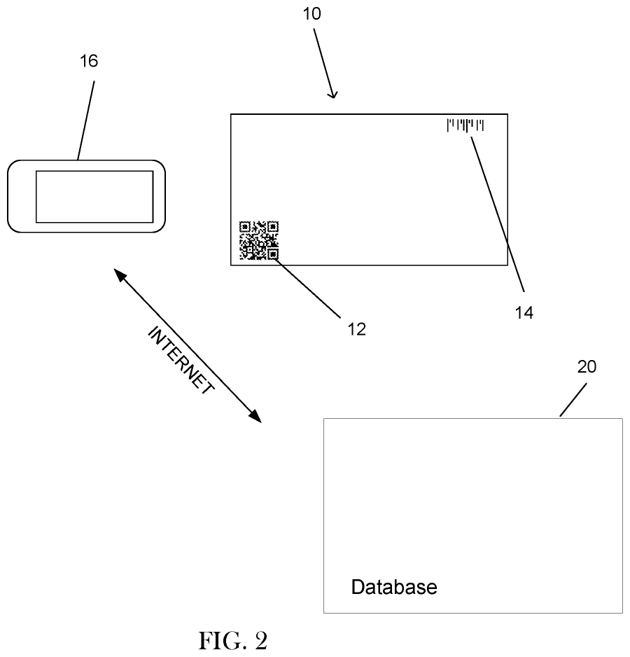

In FIG. 2, a consumer has approached baby product 10. Baby product 10 includes scan code 12 and unique markings 14. The consumer has cell phone 16 that includes a scan code reader. The consumer uses the scan code reader on cell phone 16 to scan the scan code 12. The consumer is then immediately given access through the Internet to safety data for the product that is stored on database 20. The consumer can then review the safety data for the product and feel safer that the product has been tested and evaluated by a third-party organization for safety compliance.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1) A method for verifying the safety of a baby product, said method comprising the steps of:
A. inspecting said baby product,
B. generating safety compliance documents as the result of said baby product inspection, said safety compliance documents including safety inspection results,
C. marking said baby product with unique identification markings
D. recording said unique identification markings on said safety compliance documents,
E. forwarding said baby product and said safety compliance documents to a safety verification and recording company,
F. verifying said baby product passed inspection,
G. verifying said identification markings on said baby product match said identification markings on said safety compliance documents,
H. issuing a certificate of compliance,
I. uploading said certificate of compliance and said safety inspection results to an online accessible database,
J. marking said baby product with a scan code that directs a scanner to said online accessible database, and
K. scanning said scan code to access said online database to view said certificate of compliance and said safety inspection results.

2) The method as in claim 1, wherein a consumer uses a cell phone with a scan code reader to access said online database.
